(19) United States
(12) Patent Application Publication
(10) Pub. No.: US 2021/0048528 A1
(43) Pub. Date: Feb. 18, 2021

(54) Pothole WiFi 360

(71) Applicant: Madeleine C. Lallier, Monroe, NJ (US)

(72) Inventor: Madeleine C. Lallier, Monroe, NJ (US)

(21) Appl. No.: 16/543,568

(22) Filed: Aug. 18, 2019

(51) Int. Cl. G01S 17/42; B64C 39/02; G01S 13/89

(52) U.S. Cl. CPC G01S 17/42; G01S 13/89; B64C 39/024

(57) ABSTRACT

Vehicle damages due to pothole encounters can be very costly to repair and are potentially dangerous to drivers. Pothole WiFi 360 is a solution to quickly and easily locate potholes so that they can be taken care of efficiently. The system is installed into a certain type of aerial drone that is designed as an automated solution to scan a landscape for potholes. By using radar signals, the system will detect anomalies in the pavement. The program will record the location coordinates of the pothole, based on GPS mapping systems, for workers to determine pothole locations and approximate depth. They will use this information to direct repair crews to the most severe potholes around town.

### INVENTION BACKGROUND

Vehicle damages due to pothole encounters can be very costly to repair and are potentially dangerous to drivers. Many people wish that these pavement hazards can be taken care of quickly and efficiently, but they can't be fixed if they are not found easily. “The cost of bad roads to American business between now and 2022 is estimated to be $240 billion . . . The U.S. Chamber of Commerce listed the rebuilding of America's infrastructure as one of their five top priorities in 2012.” (Cited from POTHOLE.info, © 2019, https://www.pothole.info/the-facts/.)

### INVENTION SUMMARY

Pothole WiFi 360 is a solution to quickly and easily locate potholes so that they can be taken care of efficiently. The system is installed into a certain type of aerial drone. The drone is designed to be an automated solution to pothole dangers on today's increasingly busy roads.

### INVENTION DRAWINGS

The shell of the drone will be made out of plastic—thin enough that it will not weigh down the drone, but thick enough to resist cracking in the event of any collisions with tree branches and other obstacles. Four propellers will connect to the drone body with lightweight, but sturdy plastic arms. The GPS module is meant to keep the drone on course—mapping out the landscape to ensure the device scans all roads.

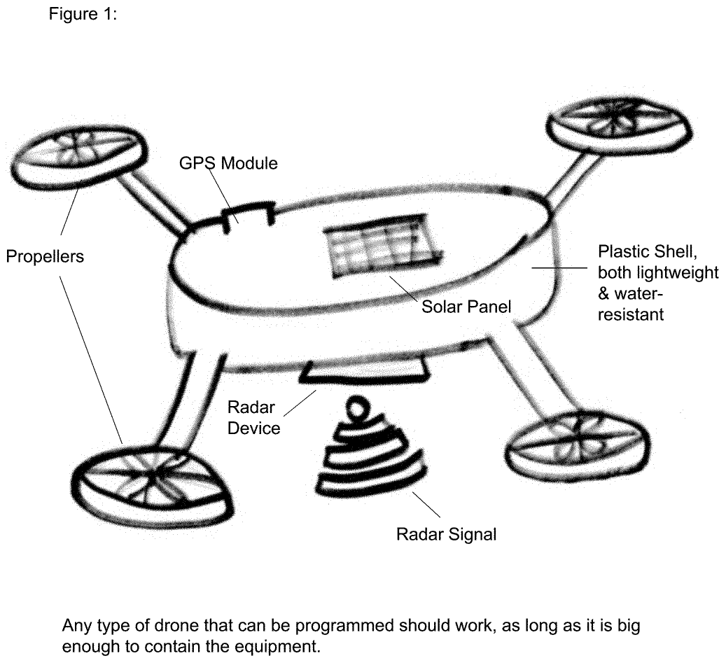

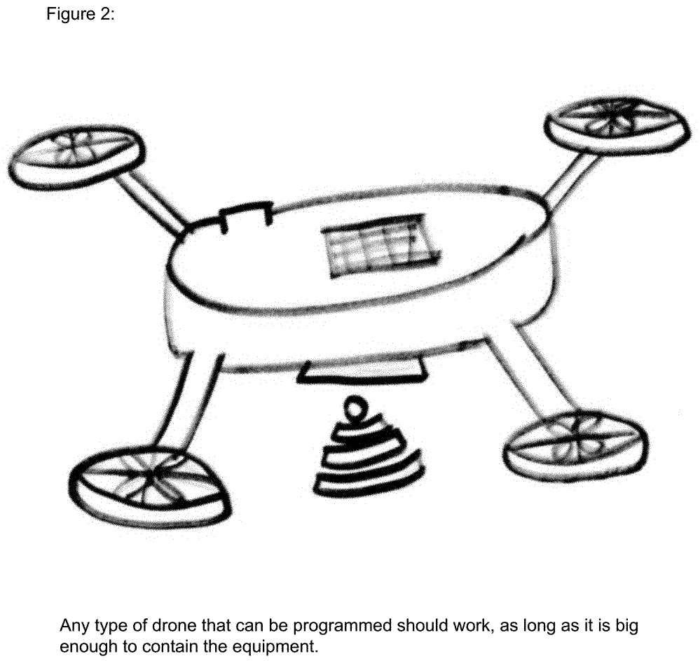

The radar device will send signals to the ground to scan for potholes, hovering at a consistent height above the roadway. This will set a standard time for radar signals to travel from the device to the road. Readings that exceed the standard time durations will indicate that a pothole has been detected. The solar panel will provide an extra boost of energy that may be needed on some days to fuel the device over longer distances. Please see FIG. 1 (With Markings) & FIG. 2 (Clean Version).

### DETAILED INVENTION DESCRIPTION

The Pothole WiFi 360 is a system that can program certain aerial drones to scan a landscape for potholes.

The drone will be programmed to fly a certain height above the street. It will send a radar signal from that height to scan the distance to the ground below it. The signal should always take the same amount of time to return to the drone over flat ground. The real elapsed time will exceed the expected time if a pothole has been detected.

The program will record the location coordinates of the pothole, based on GPS mapping systems. Once the sun begins to set, the drone will travel back to ‘headquarters’ for workers to determine pothole locations and approximate depth. They will use this information to direct repair crews to the most severe potholes around town.

The drone will run primarily on a rechargeable battery, but small solar panels on the top allow the drone to last on environmentally friendly energy.

Special Technology: Solar panels, rechargeable batteries, radar devices, GPS mapping systems (Internet connection at all times), timer

Restrictions/Additional Notes:
The model needs to be made of waterproof materials in case it gets caught in the rain without warning. To reduce cost, the shell will be made of water resistant plastic. Any electrical pieces should be as small and light as possible, but the battery shouldn't be so small that it can barely hold a charge.

1. The Pothole WiFi 360 is a real-time pothole detection system.
